(19) United States
(12) Patent Application Publication
(10) Pub. No.: US 2005/0010491 A1
(43) Pub. Date: Jan. 13, 2005

(54) Consolidated procurement management system and method

(76) Inventors: Sheng Chi Luo, Tu-Chen (TW); Zhiyong Wu, Shenzhen (CN); Brian Yan, Shenzhen (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/890,051

(22) Filed: Jul. 12, 2004

(30) Foreign Application Priority Data
Jul. 11, 2003 (TW) 92119078

(51) Int. Cl. G06F 17/60

(52) U.S. Cl. 705/26

(57) ABSTRACT

A consolidated procurement management system includes a server (2), and a plurality of buyer systems (4) and a plurality of supplier systems (5) connected to the server through a network (3). The server includes: a material requirement information receipt module (21) for receiving material requirement information from the buyer systems; a material requirement consolidation module (22) for calculating a total requirement quantity for each material, and generating consolidated material requirement data; a quote receipt module (25) for receiving quotes from the supplier systems; a purchase module (26) for determining one or more winning suppliers from a plurality of suppliers participating in price negotiations, and for generating purchase orders; and a purchase cost allocation module (29) for calculating purchase costs and expenses for each buyer, and for generating purchase cost allocation information. A related consolidated procurement management method is also disclosed.

### BACKGROUND OF THE INVENTION

1. Field of the Invention

The present invention relates generally to a procurement management system and method, and especially to an electronic procurement management system and method which can reduce purchase costs and expenses for corporations purchasing material in small amounts by collecting material requirement information received from the corporations and making a consolidated procurement.

2. Description of the Related Art

Procurement management implements and controls procurement procedures of a company, and manages suppliers of the company systematically. Efficient procurement management can make the suppliers serve the company better, and promote cooperation between the company and the suppliers. Major objectives of procurement management are to determine reasonable ordering quantities, select excellent suppliers, and help the company maintain optimal stock levels.

Traditional procurement methods generally depend on human effort to carry out purchasing procedures. For example, a company may distribute procurement information through newspapers and magazines, and may communicate with its suppliers by postal mail or telephone. Labor-intensive work is slow and can be unduly expensive. In addition, it is relatively difficult for supervisors to monitor purchasing procedures that are conducted manually. As a result, the likelihood of errors going undetected is relatively high, which detracts from the reliability of such procedures.

With the recent rapid development of computer science and information technology, electronic purchasing and online purchasing are gradually replacing more traditional labor-intensive purchasing procedures. Electronic and online purchasing has considerable advantages. For example, a purchasing company releases procurement information via an external electronic communications network. Manufacturers then access the information, and bid online for the right to be the company's supplier. In another example, a purchasing company and its suppliers set up electronic information systems linked to each other by an external network such as the Internet. The purchasing company can inquire about prices of material and send purchase orders to suppliers through the external network. The suppliers provide quotations and delivery status information to the purchasing company. In these ways, online purchasing simplifies traditional procedures, improves efficiency, and reduces costs.

Systems and methods for purchasing material with the assistance of computer science and information technology are disclosed in patents such as U.S. Pat. No. 5,970,475 issued on Oct. 19, 1999 and entitled Electronic Procurement System and Method for Trading Partners. This patent discloses an electronic commerce system enabling corporate purchasers and suppliers to electronically transact for the purchase and supply of goods/services. To enable the suppliers to supply goods/services online and process electronic orders, several software components are used for operating a supplier processor server and a supplier catalog server. To enable corporate purchasers to purchase products and services online (preferably over the Internet) from the suppliers, software is used for operating a customer server through which multiple users may log on and access the supplier servers.

U.S. Published patent application Ser. No. 2002143692 published on Oct. 3, 2002 and entitled “Fully automated, requisition-driven, competing authorized suppliers, web site-based, real-time, reverse-auction, centralized e-procurement system for government, with bifurcated internal and external modules, requisition pooling, order formulation and management, consolidated in-bound shipment and distributed J.I.T. delivery, procurement-needs prediction, centralized catalog management and numerous additional features” provides a system for selecting suppliers by way of bidding online. The main functions of the system include handling and pooling of requisition bills; order formulation, processing and tracking; consolidated, distributed, and other shipping arrangements; procurement accounting and payment authorization; supplier-relations administration; centralized procurement catalog management; procurement data analysis and report and alert generation; and procurement needs analysis.

The systems described above are typically applied in processing of purchasing procedures between a big company and a plurality of suppliers. Because a big company purchases a large amount of material each time in order to support its production, it can obtain relatively low prices from its suppliers due to mass procurement. However, medium-sized or small-scale enterprises cannot enjoy the price benefits of bulk buying if they purchase material independently from their respective suppliers, since they each require a relatively small amount of material in a certain period. This results in higher production costs for such enterprises. Therefore, what is needed is an electronic procurement management system and method which can help enterprises purchasing material in small amounts to procure the material more economically in order to reduce their purchasing costs and expenses.

### SUMMARY OF THE INVENTION

A main objective of the present invention is to provide a consolidated procurement management system and method which can reduce purchase costs and expenses for small buyers by collecting material requirement information received from the buyers and making a consolidated procurement.

To achieve the above objective, a consolidated procurement management system in accordance with a preferred embodiment of the present invention comprises a server, and a plurality of buyer systems and supplier systems connected to the server through a network. The server comprises: a material requirement information receipt module for receiving material requirement information from the buyer systems; a material requirement consolidation module for calculating a total requirement quantity for each material according to the material requirement information, and generating consolidated material requirement data; a quote receipt module for receiving quotes from the supplier systems; a purchase module for determining a plurality of winning suppliers from those participating in price negotiations according to price negotiation records, and for generating purchase orders according to the consolidated material requirement data; and a purchase cost allocation module for calculating purchase costs and expenses for each buyer according to material distribution records and total purchase costs specified in the purchase orders, and for generating purchase cost allocation information.

Further, the present invention provides a preferred consolidated procurement management method utilizing the consolidated procurement management system. The consolidated procurement management method comprises the steps of: receiving material requirement information from a plurality of buyers; calculating a total requirement quantity for each material according to the material requirement information; receiving quotes on purchased materials from a plurality of suppliers participating in price negotiations; determining a plurality of winning suppliers from those participating in price negotiations according to price negotiation records, and generating purchase orders; and calculating purchase costs and expenses for each buyer according to material distribution records and total purchase costs specified in the purchase orders, and generating purchase cost allocation information.

Other objects, advantages and novel features of the present invention will be drawn from the following detailed description of a preferred embodiment and preferred method of the present invention with the attached drawings, in which:

### BRIEF DESCRIPTION OF THE DRAWINGS

FIG. 1 is a schematic diagram of hardware configuration of a consolidated procurement management system in accordance with the preferred embodiment of the present invention;

FIG. 2 is a schematic diagram showing main function modules of a server of the system of FIG. 1; and

FIG. 3 is a flow chart of a preferred consolidated procurement management method utilizing the system of FIG. 1.

### DETAILED DESCRIPTION OF THE PREFERRED EMBODIMENT

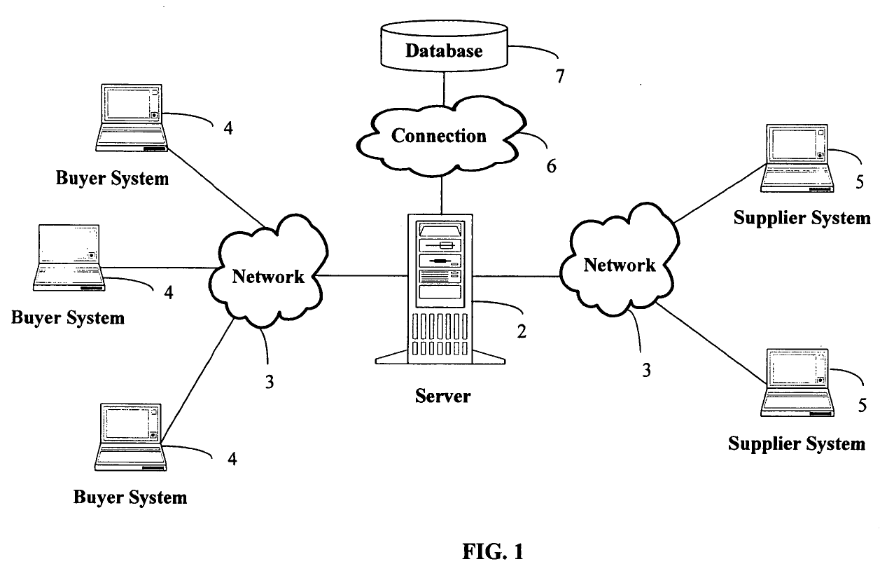

FIG. 1 is a schematic diagram of hardware configuration of a consolidated procurement management system in accordance with the preferred embodiment of the present invention. The consolidated procurement management system comprises a server 2, and a plurality of buyer systems 4 and a plurality of supplier systems 5 connected to the server 2 through a network 3. The buyer systems 4 are located where various buying entities do business. The buying entities can be different enterprises that purchase materials from the supplier systems 5, and can also be different departments within a same company that purchase materials from the supplier systems 5. Each buyer system 4 includes a plurality of devices and a plurality of software applications which allow a corresponding buyer to perform purchasing activities and communicate with the server 2. The software applications that can be executed by each buyer system 4 comprise enterprise resource planning software, email software, database management software, and other tools commonly used in a business environment.

The supplier systems 5 are located at various supplier entities that provide materials required by the buyer systems 4. Like the buyer systems 4, each supplier system 5 includes a plurality of devices and a plurality of software applications which allow a corresponding supplier to perform selling activities and communicate with the server 2. The network 3 may be any appropriate high-speed communications link known in the art, such as an intranet or the Internet.

The server 2 includes a plurality of software modules programmed to realize various functions of the consolidated procurement management system. Such functions comprise receiving material requirement information from the buyer systems 4, calculating a total requirement quantity for each material, transmitting requests for quotes to those suppliers participating in price negotiations, receiving quotes from the supplier systems 5 run by the suppliers participating in the price negotiations, determining winning suppliers, allocating purchase costs and expenses. [0018] The server 2 is connected with a database 7 via a connection 6. The connection 6 is a database connectivity, such as an ODBC (Open database connectivity) or a JDBC (Java Database Connectivity). The database 7 stores all relevant information used or generated in the consolidated procurement management system. Such information comprises material requirement information, supplier information, consolidated material requirement data, price negotiation records, purchase records, and purchase cost allocation information. The material requirement information is received from the buyer systems 4, and records requirement quantities for various materials needed by different buyers. The supplier information comprises specifications on materials provided by each supplier, such as material names, material numbers and corresponding supplier names. The consolidated material requirement data are obtained by collecting the material requirement information and calculating a total requirement quantity for each material. Each price negotiation record comprises a plurality of requests for quotes on materials, and corresponding quotes received from the supplier systems 4 in response to the requests for quotes. Each purchase record lists relevant purchase information on each material, such as a purchase order number, a purchase date, a delivery date, a supplier name, a material name, a material number, a purchase quantity, a price per unit and a total purchase cost. The purchase cost allocation information stores purchase costs allocated to different buyers.

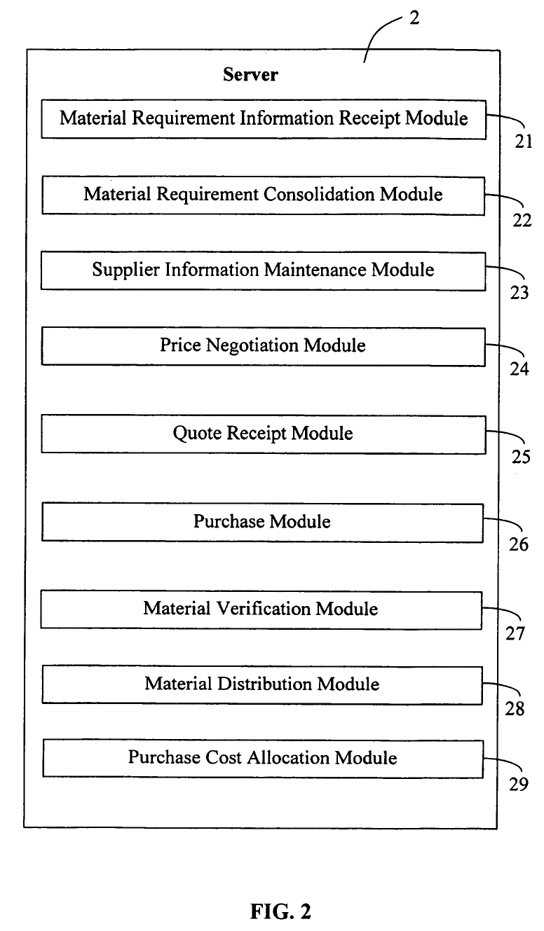

FIG. 2 is a schematic diagram showing main function modules of the server 2. The server 2 comprises a material requirement information receipt module 21, a material requirement consolidation module 22, a supplier information maintenance module 23, a price negotiation module 24, a quote receipt module 25, a purchase module 26, a material verification module 27, a material distribution module 28, and a purchase cost allocation module 29. The material requirement information receipt module 21 is provided for receiving material requirement information from the buyer systems 4. The material requirement consolidation module 22 calculates a total requirement quantity for each material according to the material requirement information, and generates consolidated material requirement data. The supplier information maintenance module 23 provides specifications on materials supplied by each supplier, and can select a plurality of suppliers from a group of suppliers supplying a same purchased material to participate in price negotiations.

The price negotiation module 24 generates requests for quotes on the purchased materials according to the material requirement information and the supplier information, and transmits the requests for quotes to the selected suppliers. Each request for quote may be in respect of one or more materials. The request for quote comprises a name of each material needing a quote, a required quantity of each material, a delivery date, and a price negotiation due date. The quote receipt module 25 provides an operating interface for the selected suppliers to log on the consolidated procurement management system, and to submit their respective quotes on the purchased materials. The quote receipt module 25 further generates price negotiation records according to the received quotes, and stores the price negotiation records in the database 3.

The purchase module 26 determines a plurality of winning suppliers from the selected suppliers based on the price negotiation records, and generates purchase orders according to the consolidated material requirement data. The purchase orders are transmitted to corresponding supplier systems 5 run by the winning suppliers. Each purchase order may be in respect of one or more materials. The purchase order comprises a purchase order number, a purchase date, a delivery date, a supplier name, a name and specifications for each purchased material, a price per unit for each purchased material, and total purchase costs. The material verification module 27 facilitates operators using the consolidated procurement management system, such as warehousemen and purchase managers, to physically check the materials delivered by the suppliers according to the purchase orders. The material distribution module 28 distributes the checked materials to corresponding buyers according to the material requirement information received from the buyers, and generates material distribution records. The purchase cost allocation module 29 calculates purchase costs and expenses for each buyer according to the material distribution records and total purchase costs specified in the purchase orders, and generates purchase cost allocation information. The purchase cost allocation module 29 then transmits the purchase cost allocation information to the buyers.

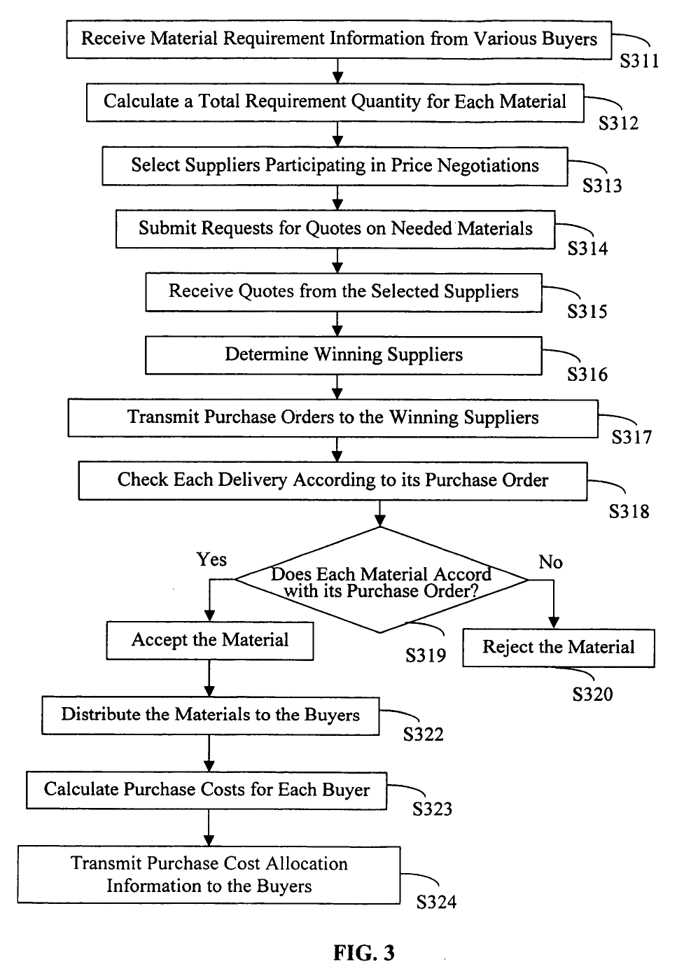

FIG. 3 is a flow chart of a preferred consolidated procurement management method implementing the consolidated procurement management system described above. In step S311, the material requirement information receipt module 21 receives material requirement information from the buyer systems 4. In step S312, the material requirement consolidation module 22 calculates a total requirement quantity for each material according to the material requirement information, and generates consolidated material requirement records. In step S313, the price negotiation module 24 obtains supplier information from the supplier information maintenance module 23, and selects a plurality of suppliers to participate in subsequent price negotiations according to the material requirement information. In step S314, the price negotiation module 24 generates requests for quotes on purchased materials, and submits the requests for quotes to the supplier systems 5 operated by the selected suppliers. In step S315, the selected suppliers log on the consolidated procurement management system, and submit their quotes through the operating interface provided by the quote receipt module 25. The quote receipt module 25 receives the quotes, and generates price negotiation records.

When the price negotiation due date expires, in step S316, the purchase module 26 determines a plurality of winning suppliers to deliver the purchased materials according to the price negotiation records. In step S317, the purchase module 26 generates purchase orders according to the consolidated material requirement data, and transmits the purchase orders to corresponding supplier systems 5 run by the winning suppliers.

In the preferred method, all the materials are delivered by the suppliers to a central warehouse (or distribution hub). When each delivery arrives at the warehouse, in step S318, warehousemen (or purchase managers) obtain the corresponding purchase order from the database 3, and physically check each material against the purchase order. In step S319, the warehousemen determine whether all the delivered materials accord with the specifications for the purchased materials in the purchase order.

If any delivered material does not accord with the purchase order, in step S320, the warehousemen or purchase managers reject the delivered material. If all the delivered materials accord with the purchase order, in step S321, the warehousemen accept the materials. If and when all the delivered materials from all the suppliers are accepted, in step S322, the warehousemen distribute the materials to the corresponding buyers according to the material requirement information, and the material distribution module 28 generates material distribution records. In step S323, the purchase cost allocation module 29 calculates purchase costs and expenses for each buyer according to the material distribution records and total purchase costs comprised in the purchased orders, and generates purchase cost allocation information. In step S324, the purchase cost allocation module 29 transmits the purchase cost allocation information to the buyers.

Although the present invention has been specifically described on the basis of a preferred embodiment and preferred method, the invention is not to be construed as being limited thereto. Various changes or modifications may be made to the embodiment and method without departing from the scope and spirit of the invention.

1. A consolidated procurement management system comprising a server, and a plurality of buyer systems and a plurality of supplier systems connected to the server through a network, wherein the server comprises:
a material requirement information receipt module for receiving material requirement information from the buyer systems;
a material requirement consolidation module for calculating a total requirement quantity for each of one or more materials according to the material requirement information, and generating consolidated material requirement data;
a quote receipt module for receiving quotes from the supplier systems;
a purchase module for determining one or more winning suppliers from a plurality of suppliers participating in price negotiations according to price negotiation records, and for generating one or more purchase orders according to the consolidated material requirement data; and
a purchase cost allocation module for calculating purchase costs and expenses for each of buyers according to material distribution records and total purchase costs specified in said purchase orders, and for generating purchase cost allocation information.

2. The consolidated procurement management system according to claim 1, wherein the server further comprises a supplier information maintenance module for providing specifications on one or more materials supplied by each supplier, and for selecting a plurality of suppliers from those supplying one or more needed materials to participate in price negotiations.

3. The consolidated procurement management system according to claim 2, wherein the server further comprises a price negotiation module for generating requests for quotes on said needed materials according to the material requirement information and the supplier information, and transmitting the requests for quotes to respective selected suppliers.

4. The consolidated procurement management system according to claim 1, wherein the server further comprises a material verification module for one or more operators of the consolidated procurement management system to physically check said needed materials delivered by said winning suppliers according to said purchase orders.

5. The consolidated procurement management system according to claim 1, wherein the server further comprises a material distribution module for distributing said materials to corresponding buyers according to the material requirement information received from the buyers, and for generating material distribution records.

6. A consolidated procurement management method comprising the steps of:
receiving material requirement information from a plurality of buyers;
calculating a total requirement quantity for each of one or more materials according to the material requirement information;
receiving quotes on one or more needed materials from a plurality of suppliers participating in price negotiations;
determining one or more winning suppliers from the plurality of suppliers participating in price negotiations according to price negotiation records, and generating one or more purchase orders; and
calculating purchase costs for each buyer according to material distribution records and total purchase costs specified in said purchase orders, and generating purchase cost allocation information.

7. The consolidated procurement management method according to claim 6, further comprising the step of selecting a plurality of suppliers to participate in price negotiations according to supplier information and the material requirement information.

8. The consolidated procurement management method according to claim 7, further comprising the step of submitting requests for quotes to the selected suppliers.

9. The consolidated procurement management method according to claim 6, further comprising the step of checking said needed materials delivered by said winning suppliers to determine whether said needed materials accord with specifications in said purchase orders.

10. The consolidated procurement management method according to claim 9, further comprising the step of rejecting said delivered materials if any delivered material does not accord with the specifications in said purchase orders.

11. The consolidated procurement management method according to claim 9, further comprising the step of distributing said delivered materials to the buyers according to the material requirement information.

12. The consolidated procurement management method according to claim 6, further comprising the step of transmitting the purchase cost allocation information to the buyers.

13. A consolidated procurement management method comprising the steps of:
receiving material requirement information from a plurality of different buyers;
calculating a total requirement quantity for each of one or more different materials according to the material requirement information;
receiving quotes on one or more needed materials from a plurality of different suppliers participating in price negotiations; and
determining one or more different winning suppliers from the plurality of different suppliers participating in price negotiations;
the one or more different winning suppliers, who can lower a unit price of the different materials, being based upon consideration of total quantities of the one or more different materials required by the plurality of different buyers.
